(19) United States
(12) Patent Application Publication
(10) Pub. No.: US 2003/0031321 A1
(43) Pub. Date: Feb. 13, 2003

(54) System and method for using a smart card for wireless or wired remote gaming activities

(76) Inventor: Ken Mages, Highland Park, IL (US)

Correspondence Address: Max Shaftal, PATZIK, FRANK & SAMOTNY, LTD., Suite 900, 150 South Wacker Drive, Chicago, IL, 60606, US

(21) Appl. No.: 10/214,650

(22) Filed: Aug. 8, 2002

Related U.S. Application Data
(60) Provisional application No. 60/311,233, filed on Aug. 9, 2001.

(51) Int. Cl. H04L 9/00

(52) U.S. Cl. 380/270; 713/186; 380/251

(57) ABSTRACT

A system and method for accurately identifying the user of wireless or wired devices used for playing casino games. The system includes a smart card reader associated with the device for reading information about the authorized user from a smart card. The information stored on the smart may include the amount of money left on the card or in the user's account, as well as identification information such as a password or fingerprint associated with the authorized user. If the user enters the correct identification, then the device will proceed to allow gaming activities to be played. In addition to recording the balance remaining on the card, the smart card may also monitor and record information concerning the activities performed on the device to assist the casino in its reward program.

This application claims priority based upon U.S. Provisional Patent Application Serial No. 60/311,233 filed Aug. 9, 2001.

### FIELD OF THE INVENTION

This invention relates in general to gaming activities, and more particular to a system and method for allowing wireless or wired remote gaming activities, and still more particularly to a system and method for allowing wireless or wired remote gaming activities that utilizes a smart card to store and transmit data for participating in the gaming activities and to ensure that the device is only used by an authorized user.

### BACKGROUND OF THE INVENTION

Casinos provide a venue for people to participate in gaming activities. As an incentive to encourage casino patrons who wager larger amounts of money to return, casinos often monitor the activities of the casino patrons and provide rewards or perks (sometimes known in the industry as “comps”) based on the level of wagering activity of the patrons. Comps may include free meals, discounted or free stays at the casino hotel, tickets to various entertainment shows and the like. In addition to knowing the amount of money a particular patron spends (or at least wagers), it is also beneficial for the casino to know how the patron spends his or her time when at the casino. In particular, a patron who is receiving a free room is expected to spend a good deal of time wagering at the gaming tables. Collecting information (i.e., mining data) on how patrons spend their time while in the casino or on casino grounds allows for the casino to use that information to better direct its services and activities to the particular patron.

Recently, there has been a push for casinos to provide services to enable their patrons to remotely participate in gaming activities. Therefore, instead of having to physically sit down at a table or machine, the patron may participate in gaming activities from other locations such as in a shopping mall or on a golf course. However, various laws limit the areas where gambling activity may legally take place. In particular, the Las Vegas Gaming Commission currently does not allow off-site casino gambling. In addition to verifying the correct time and location of a user on the casino property to ensure that the activity is legally transacted, it also is imperative that the use of the device be limited to the authorized user to prevent unauthorized gaming activities from taking place.

Therefore, there is a need to produce a system that enables secured, verified gaming from a remote location that is economical and easy to manufacture and use.

### SUMMARY OF THE INVENTION

The present invention is an improvement over the prior devices that allowed for remote gaming activities in that the way that the device retrieves and verifies information concerning authorized users is unique and an improvement over the prior art. In particular, the device of the present invention includes a smart card reader for accepting a smart card that contains information concerning the identity of the user. Such information may include passwords associated with the user or a copy of a thumbprint or the user to allow for the user to input the password or thumb print into the device to verify that the user is authorized to participate in gaming activities. If the device is used in connection with a casino, the smart card may also contain information concerning the authorized user's account, credit limit or amount remaining on the card.

It is therefore an object of the present invention to provide a new and improved system and method for enabling remote gaming activities by an authorized user.

Another object of the present invention is to provide a system for ensuring that the user of a device is authorized to participate in remote gaming activities.

A still further object of the present invention is to provide a system for providing for the secure exchange of data.

A still yet further object of the present invention is to provide a system for enabling remote gaming activities that is easy and economical to manufacture for wired or wireless gaming device.

Other objects, features and advantages of the invention will be apparent from the following detailed disclosure, taken in conjunction with the accompanying sheets of drawings, wherein like reference numerals refer to like parts.

### BRIEF DESCRIPTION OF THE DRAWINGS

FIG. 1 is a block diagram illustrating a device operably connected to the Internet to participate in gaming activities and a plurality of transmitters which in turn are operably connected to a CDMA server within a building and a GPS base station and associated GPS antenna outside the building.

FIG. 2 is a schematic view of an embodiment of a wireless device of the present invention.

FIG. 3 is a vertical plan view of an embodiment of a wireless device of the present invention illustrating the display area of the wireless device including a list of possible gaming activities to play.

FIG. 4 is an exploded view of an embodiment of a smart card that may be used with the present invention.

FIG. 5 is a simplified flow chart diagram of the steps involved in verifying and playing a gaming activity from a wireless device.

### DETAILED DESCRIPTION OF THE INVENTION

While this invention is susceptible of embodiment in many different forms, there is shown in the drawings and will herein be described in detail several specific embodiments, with the understanding that the present disclosure is to be considered merely an exemplification of the principles of the invention and the application is limited only to the appended claims.

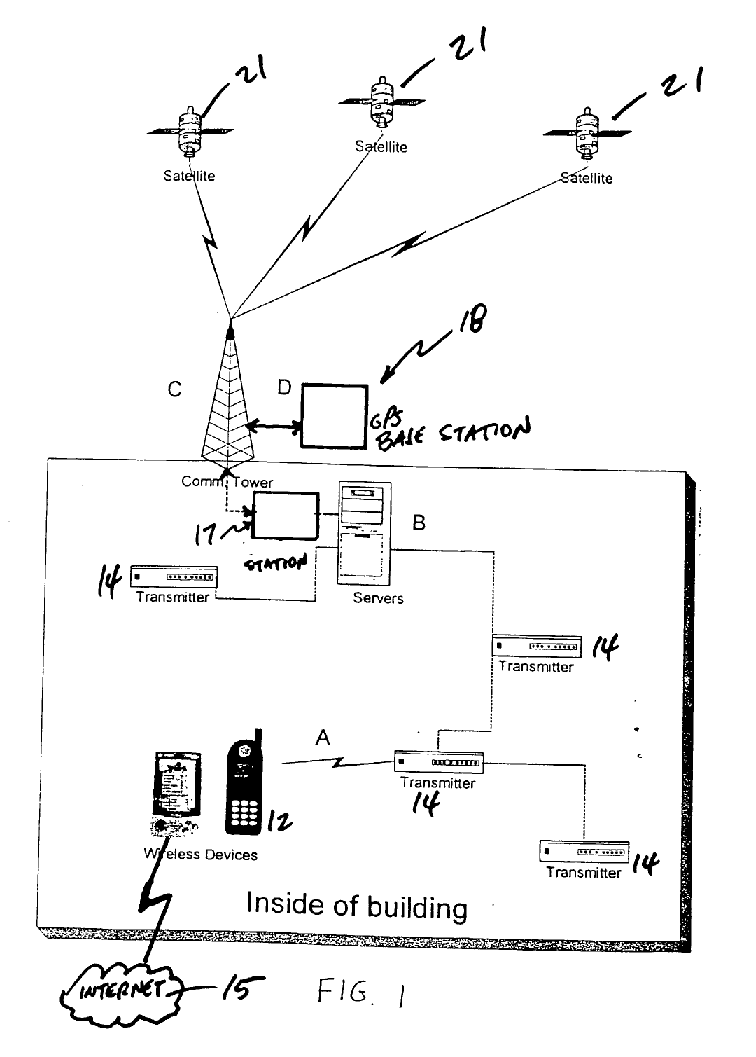

Referring now to the drawings, and particularly to FIG. 1, there is shown an example of an assisted global positioning system (hereinafter “AGPS”) that may be used with the present invention to provide wireless or wired gaming activities. While a system and method for performing gaming activities is shown and disclosed, it is appreciated that the present invention may be used for other transactions including, but not limited to, bank transactions and store purchases. Additionally, while the present system is shown as including the system of global positioning satellites to determine the location of the device, it is appreciated that the present invention may be used with any system of the type generally known in the prior art for providing gaming activities, including systems that do not determine or provide the location of the device or other systems for determining location.

The AGPS, generally designated by the number 10, is shown as having a device 12 operably connected to a plurality of transmitters 14 located throughout the inside of a building 16 to accurately determine the location of the device 12. Information collected from the device may then be transmitted to a microbase transceiver station 17, which in turn transmits the information to a GPS base station 18 having GPS base station circuitry and a GPS antenna 20 for transmitting and/or receiving the information or other transmissions to or from one of a plurality of GPS satellites 21 orbiting the earth. While GPS is referred to in the preferred embodiment herein as the method for locating the user, other location methods or triangulation-based technology should be considered as being within the scope of this invention. The device is also preferably connected to the Internet 15 or a server associated with a casino to enable the device to offer gaming activities. While the transmitters are shown as being located within the interior of a building, it is appreciated that they also may be located outside the building as well, so as to assist in determining the location of the device outside. It is also appreciated that the transmitters may transmit the information directly to the device, which in turn transmits the information to the GPS base station.

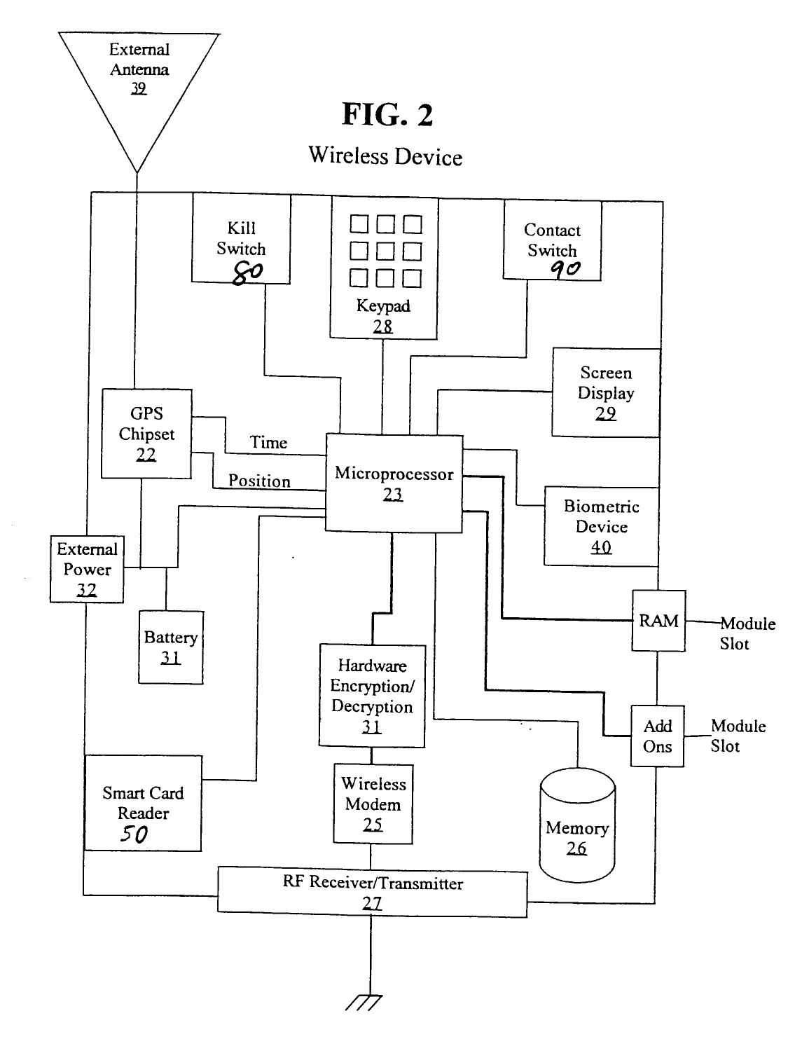

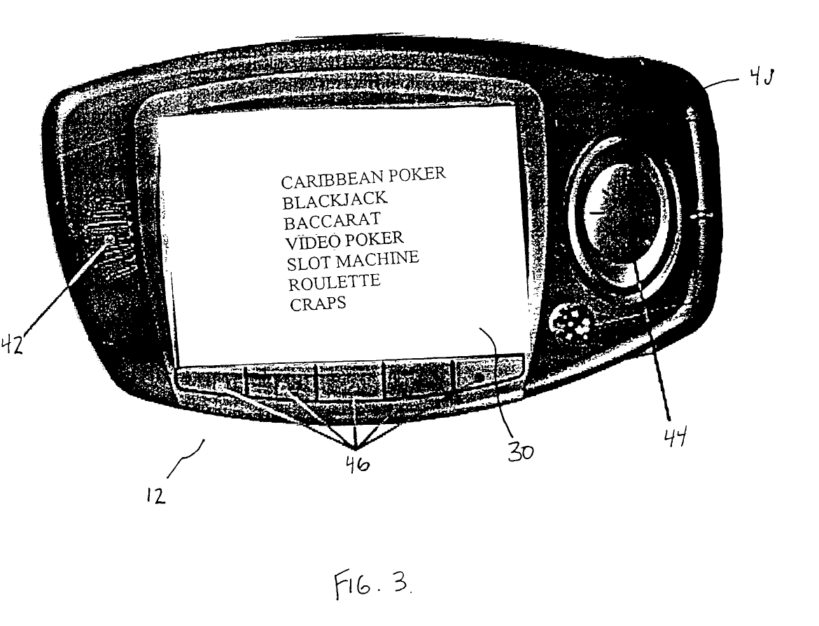

Referring now to FIGS. 2 and 3, a wireless device for use in the present invention is shown. As shown in FIG. 2, the wireless device 12 may include a GPS chipset 22 for providing time and geographic position data to a microprocessor 23, means for providing hardware encryption and decryption of all information sent or received 24 from the wireless device 12, and a wireless modem 25 or other means for connecting to the Internet 15, remote server or the like. The wireless device 12 is also provided with memory 26, a RF or IR receiver/transmitter 27, a keypad 28 for manually inputting data and a display screen 30.

Alternatively, display screen 30 can be a touch screen that serves as both the keypad for inputting information and the display screen. The keypad 28 can also be a peripheral device such as an external keyboard or a series of buttons 46 and a multidirectional thumb pad 44. Likewise, hardware encryption/decryption can be provided by the GPS chipset 22. Also provided are an external GPS antenna 39 and a receiver/transmitter antenna 38. The GPS chipset 22, kill switch 80, keypad 28, contact switch 90, screen display 30, biometric device 40, ram module slot 95, memory 26, external power 32, battery 31 and RF receiver/transmitter are all connected to microprocessor 23. It also is appreciated that the wireless device may include any other components known in the art to allow a wireless device to send, retrieve and display information to participate in wireless gaming activities.

As shown in FIG. 2, the wireless device 12 includes the viewing or display screen 30, such as an LCD screen, for displaying information; one or more speakers 42 for providing voice or sound in conjunction with the selections or results; and a multi-directional thumb pad 44 and a series of button 46 on the face 48 of the wireless device 12 for selecting and playing the various gaming activities or games associated with the wireless device. The example of the wireless device 12 is sized so that it may be readily transported throughout the casino building 16. While a modular wireless device is shown, it is appreciated that the device may be a cellular phone, a wireless device having cellular phone capabilities, other wireless devices such as PDAs and the like, or a wired gaming device.

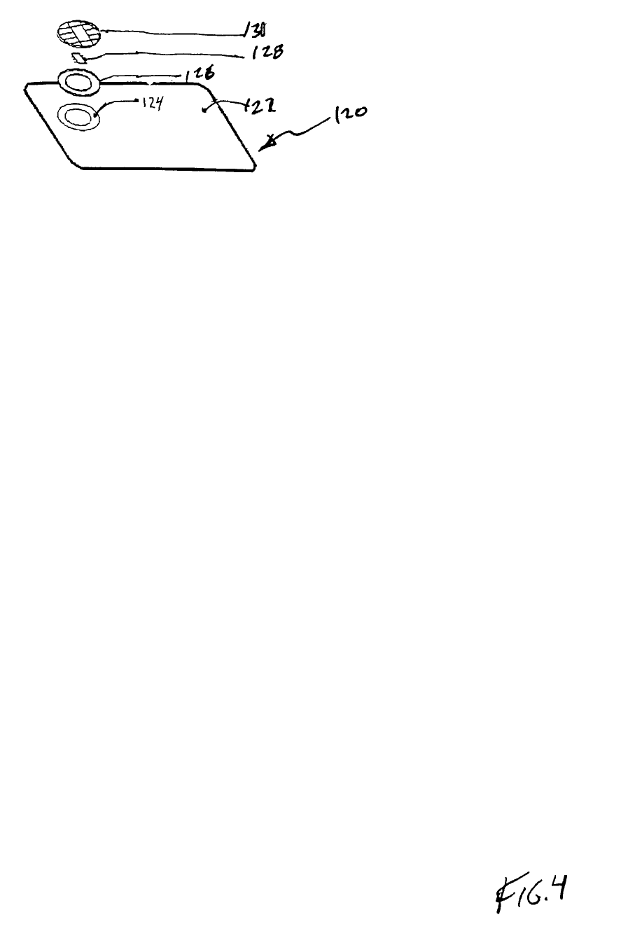

Referring now to FIG. 4, the biometric device 40 is shown on the back of the wireless device 12. The biometric device may consist of a fingerprint scanner or a retinal scanner to ensure that any uses of the wireless device are authorized. Examples of a biometric thumbprint scanner are the U-Match Biolink or the ThumbTrax® devices. While the biometric device is shown as integrated into the back of the wireless device, it is appreciated that the biometric device may be located elsewhere on the wireless device or externally connected to the wireless device in a known way.

Additionally, the wireless device includes a conventional smart card reader 50 of the type generally known in the prior art for accepting a smart card containing information pertaining to the authorized use of the wireless device. While the smart card reader is preferably integrally located on the side of the wireless device, it is appreciated that the smart card reader may be a peripheral device that is connected to the wireless device in a known way.

The smart card reader may be designed to accept either a contact or a contactless smart card. FIG. 4 shows one embodiment of a contact smart card. The smart card 120 includes a plastic housing or card 122 having a cavity 124 for accepting a micromodule comprised of a micro-controller 128 and a printed circuit 130. The micromodule may be attached to the card using glue 126 in a cold or hot glue process or by any other known means. The smart card is designed to store data and information pertaining to the use of the wireless device. For example, the smart card may be loaded with a specific monetary value that may be purchased from a casino to allow the participation in gaming activities up to the specific amount remaining on the card. Alternatively, the smart card may be loaded with financial information related to the use of the wireless device to participate in gaming activities. Such financial information may include, but is not limited to, a credit limit for gaming activities. It is also appreciated that the smart card may monitor and record the activities performed on the wireless device in association with particular loyalty or incentive programs that offer rewards based upon the amount of money wagered at the casino.

In addition to the financial information, the smart card preferably stores identity information to verify that the gaming activities may be legally transacted. For example, the smart card may include a password that must be inputted before the wireless device will permit gaming activities to be performed. Gaming activities are therefore limited to uses where the proper password is inputted. Other information stored on the smart card may include, but is not limited to, biometric information such as a fingerprint that may be compared to a fingerprint scanned through a biometric scanner to ensure proper use of the wireless device.

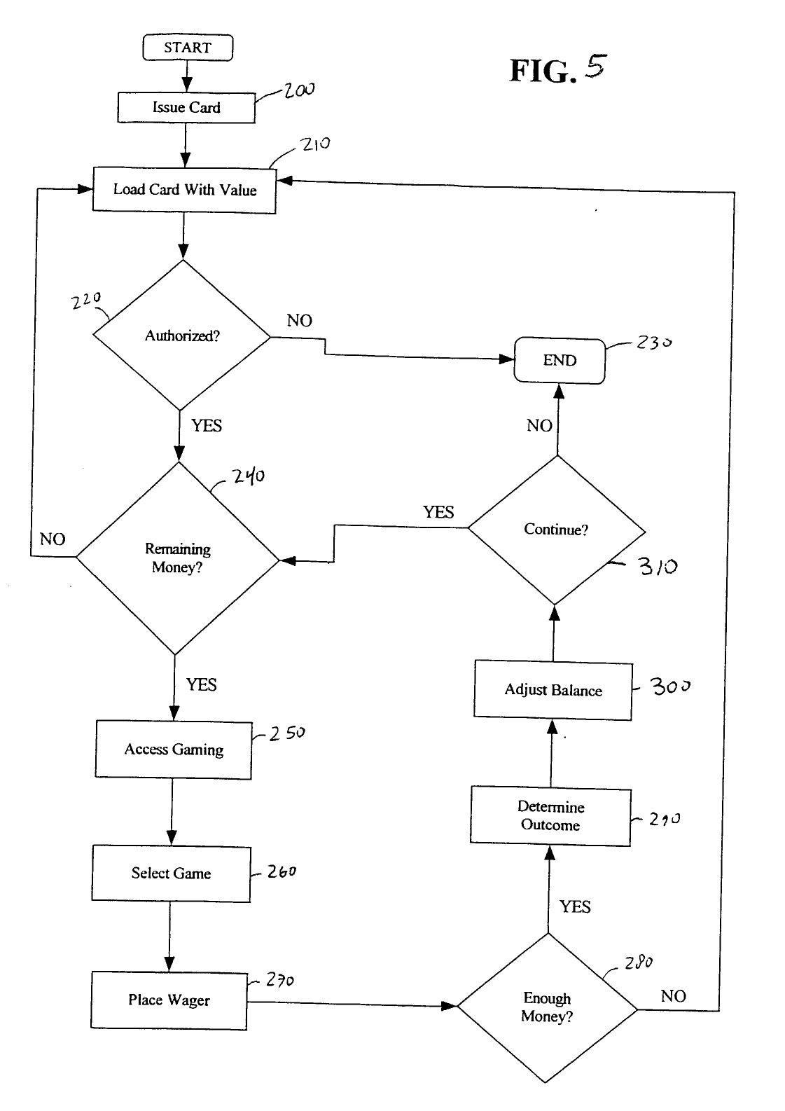

Referring to FIG. 5, the preferred steps in wirelessly playing a game are shown. In order to operate the wireless device to participate in gaming activities, a smart card must be issued or provided by the casino or other provider in step 200. Before issuing the card, the casino completes a registration process that verifies that gaming activities may be legally transacted.

Once it is determined that gaming activities may be legally transacted, the smart card may be loaded with a particular dollar value in step 210. Alternatively, information concerning a particular credit limit or current balance may be inputted into the smart card.

After the smart card is inserted into the wireless device, the wireless device will prompt for identity information to be inputted. Once inputted, the identity information will be compared with the information stored on the card to determine if the use is authorized in step 220. For example, insertion of the card into the wireless device may result in the wireless device prompting for a date of birth or other password associated with the authorized use of the wireless device. If the inputted password matches the password stored on the smart card, gaming activities may proceed. On the other hand, if the passwords do not match, an error message is displayed in step 230 and gaming activities are not permitted to be played. Likewise, if a thumbprint provided to the biometric device matches the thumbprint stored on the smart card, then gaming activities are allowed. If the thumbprints do not match, further access is denied. Additionally, the wireless device may communicate with the AGPS to determine its location to verify that wireless device is in an area where gaming activities are lawfully permitted.

If it is determined that sufficient money remains on the smart card in step 240 then the wireless device will proceed to offer gaming activities in step 250. Otherwise, additional value must be added to the card in step 210. Participation in gaming activities includes selecting a particular game in step 260 and placing a wager in step 270. After the wager is inputted, the wireless device will compare the wager amount with the value stored on the smart card to determine whether there are sufficient funds to cover the wager in step 280. If the value stored on the smart card is less than the wager placed, then additional value must be added to the card in step 210. It is also appreciated that the wireless device may indicate that there are insufficient funds to cover the wager and prompt for a different wager amount to be inputted.

If, on the other hand, the value stored on the smart card equals or exceeds the wager placed, then the gaming activity is allowed to proceed to completion. Upon completion of the gaming activity in step 290, the value contained in the card will be credited or charged accordingly in step 300. After the balance is adjusted, additional gaming activities may be played if it is determined that there is any remaining value on the smart card in step 240. Additional value may be added to the card as needed in step 210 in order to continue to participate in gaming activities. If it is not desired to continue to play gaming activities in step 310, then the wireless device will terminate the connection to the Internet or remote server to cease the gaming activities in step 230.

While a device connected by wire or wirelessly to the Internet, network or casino server is described in the foregoing examples, the aforementioned kill switches of the present invention would be applicable to a stand-alone, handheld or portable device, as well.

It will be understood that modifications and variations may be effected without departing from the scope of the novel concepts of the present invention, but it is understood that this application is limited only by the scope of the appended claims.

1. A system for verifying that a device that is capable of handling transactions is used by an authorized user comprising:
a smart card, wherein the smart card contains information related to the authorized user;
a device having a smart card reader for reading the information on the smart card and means to identify the authorized user based on the information on the smart card so as to allow the transactions only when the device verifies that the device is used by an authorized user.

2. The system according to claim 1 wherein the device is a wireless device.

3. The system according to claim 2 which further includes means to provide gaming activities.

4. The system of claim 3 wherein the identifying means is a biometric scanner.

5. The system of claim 4 wherein the biometric scanner is a fingerprint scanner and wherein the information stored on the smart card includes a copy of the authorized user's fingerprint.

6. The system of claim 3 wherein the identifying means is a password and wherein the information stored on the smart card includes the password.

7. The system of claim 3 wherein the information stored on the smart card includes financial information concerning the authorized user.

8. The system of claim 3 wherein the information stored on the smart card is a monetary dollar amount.

9. The system of claim 3 wherein the smart card is a contact smart card.

10. The system of claim 3 wherein the smart card is a contactless smart card.

11. The system of claim 3 which further comprises means to record information on the smart card.

12. The system of claim 11 wherein the recorded information includes the duration of time spent playing a game and the amount of money wagered.

13. The system of claim 3 wherein the means to play gaming activities includes means to connect the wireless device to the Internet.

14. The system of claim 3 wherein the means to play gaming activities includes means to connect the wireless device to a remote server.

15. The system of claim 3 which further includes means to verify the location of the wireless device.

16. A system for permitting an authorized user to participate in gaming activities comprising:
a smart card, wherein the smart card contains a stored value and information related to the authorized user;
a device having means to read the information on the smart card and means to identify the authorized user;
means to provide gaming activities;
means to compute and display results of the gaming activities; and
means to adjust the stored value on the smart card based on the results of the gaming activities.

17. The system of claim 16 wherein the device is a wireless device.

18. A method for verifying that a device is used by an authorized user to perform a transaction comprising the steps of:
providing a device having a smart card reader and means to identify the authorized user;
providing a smart card, wherein the smart card includes information related to the authorized user;
allowing the smart card to communicate information related to the authorized user to the smart card reader;
requesting the authorized user to input identification information;
comparing the inputted identification information with the information stored on the smart card; and
selectively allowing the transaction to proceed depending on the comparison of the inputted identification information and the information stored on the smart card.

19. The method of claim 18 wherein the device is a wireless device.

20. The method of claim 19 which further includes the steps of determining the location of the wireless device and selectively allowing the transaction to proceed depending on the location of the wireless device.

21. The method of claim 19 which further includes the step of connecting the wireless device to the Internet to allow the wireless device to offer gaming activities.

22. The method of claim 19 which further includes the step of connecting the wireless device to a computer network of a casino to allow the wireless device to offer gaming activities.

23. A method for verifying the identity of a user of a device for participating in gaming activities associated with a casino, the method comprising the steps of:
providing a device for participating in gaming activities, wherein the device includes a smart card reader and means to identify the authorized user;
providing a smart card, wherein the smart card includes stored information related to the authorized user;
allowing the smart card to communicate the stored information related to the user with the smart card reader;
requesting the authorized user to input identification information;
comparing the inputted identification information with the information stored on the smart card; and
selectively allowing the gaming activities to proceed depending on the comparison of the inputted identification information and the information stored on the smart card.

24. The method of claim 23 wherein the device is a wireless device.

25. The method of claim 24 which further includes the step of connecting the wireless device to the Internet to allow the wireless device to offer gaming activities.

26. The method of claim 24 which further includes the step of connecting the wireless device to a computer network of the casino to allow the wireless device to offer gaming activities.

27. The method of claim 24 wherein the step of comparing the inputted information with the information stored on the smart card comprises a biometric scanner.

28. The method of claim 27 wherein the biometric scanner is a fingerprint scanner.

29. The method of claim 28 wherein the information stored on the smart card includes a copy of the authorized user's fingerprint.

30. The method of claim 24 wherein the identification information is a password and wherein the password is stored on the smart card.

31. The method of claim 24 wherein the information stored on the smart card includes financial information concerning the authorized user.

32. The method of claim 24 wherein the information stored on the smart card is a monetary dollar amount.

33. The method of claim 24 wherein the smart card is a contact smart card.

34. The method of claim 24 wherein the smart card is a contactless smart card.

35. The method of claim 24 which further comprises means to record information on the smart card.

36. The method of claim 35 wherein the recorded information includes the duration of time spent playing a game and the amount of money wagered.

37. A method for allowing a device user to participating in gaming activities associated with a casino, the method comprising the steps of:
providing a device for participating in gaming activities, wherein the device includes a smart card reader and means to identify the authorized user;
connecting the device to a source for gaming activity;
providing a smart card, wherein the smart card includes information related to the authorized user and a stored value;
allowing the smart card to communicate the information regarding the authorized user and the stored value to the smart card reader;
requesting the authorized user to input identification information;
comparing the inputted identification information with the information stored on the smart card;
selectively allowing the transaction to proceed depending on the comparison of the inputted identification information and the information stored on the smart card;
offering at least one gaming activity to be played on the device;
indicating the results of the gaming activity; and
adjusting the stored value on the smart card based on the results of the gaming activity.

38. The method of claim 37 wherein the device is a wireless device.

39. The method of claim 38 which further includes the steps of determining the location of the wireless device and selectively allowing the gaming activities to proceed depending on the location of the device.

40. The method of claim 38 wherein the source of gaming activity comprises the Internet.

41. The method of claim 38 wherein the source of gaming activity comprises a computer network of the casino.
